(19) United States
(12) Patent Application Publication
(10) Pub. No.: US 2020/0157877 A1
(43) Pub. Date: May 21, 2020

(54) DOOR SYSTEM WITH DUAL SEALING ELEMENTS

(71) Applicant: NOVATECH CANADA INC., Sainte-Julie (CA)

(72) Inventors: Normand McKinnon, Quebec (CA); Robert Daoust, Quebec (CA); René Massicotte, Quebec (CA); Liviu Ciuca, Quebec (CA); Marc-Antoine Dion, Quebec (CA)

(21) Appl. No.: 16/199,120

(22) Filed: Nov. 23, 2018

Related U.S. Application Data
(60) Provisional application No. 62/590,427, filed on Nov. 24, 2017.

(51) Int. Cl. E06B 7/14; E06B 7/23; E06B 1/70; E06B 3/72

(52) U.S. Cl. CPC E06B 7/14; E06B 7/2305; E06B 3/72; E06B 7/2316; E06B 1/70

(57) ABSTRACT

A high-performance door system is provided. The door system comprising a door leaf having a framework which includes first and second stiles spaced apart from each other, a first rail joining a first end of the first stile with a first end of the second stile, and a second rail joining a second end of the first stile with a second end of the second stile. The first rail is provided with a groove, and each one of the stiles comprises an inner channel, each inner channel being in fluid communication with the groove. The door leaf further comprises a housing defining a hollow space which is then injected with filler material so as to fill the hollow space and the groove, thereby spreading to each one of the inner channels, thus sealing interstices between the rail and stiles.

### CROSS-REFERENCE TO RELATED APPLICATIONS

This application claims priority to U.S. Provisional Application No. 62/590,427, filed Nov. 24, 2017, the entire contents of which are incorporated by reference herein.

### TECHNICAL FIELD

The technical field generally relates to doors. More particularly, the present invention relates to a high-performance door system with dual continuous sealing elements.

### BACKGROUND

Most entrance door systems with a straight edge and current side hinges no longer meet a number of new standards or specifications including the following standards: North American Fenestration Standard (NAFS)/Specification for windows, doors and skylights (AAMA/WDMA/CSA 101/IS2/A440-08). Reliability of existing systems regarding their performance is not always assured. The evolution of new standards forces door designers to find new solutions in an attempt to respect key performance criteria such as structural integrity, resistance to water penetration, resistance to air infiltration and the thermal resistance. With new standards, new requirements for each installed door system mainly depend on the geographic area, elevation of the installation, the type of terrain and the type of building where the door is to be installed.

North American door configurations include gasket and hinge arrangements that result in discontinuous seals around a periphery of the door, or seals that are joined at corners at 45° cut angles in certain cases. Such seal arrangements result in air or fluid leaks through the door system which decrease resistance to water penetration and air infiltration.

Hence, in light of the aforementioned, there is a need for a door system which, by virtue of its design and components, would be able to overcome or at least minimize some of the aforementioned prior art problems.

### SUMMARY

According to a first aspect, there is provided a door leaf including a framework having a first stile and a second stile spaced apart from the first stile, a first rail joining a first end of the first stile with a first end of the second stile, and a second rail joining a second end of the first stile with a second end of the second stile. The first rail has a first inner surface provided with a first groove extending therealong, and each one of the first and second stiles respectively have an inner channel extending along a length thereof, each inner channel being in fluid communication with the first groove of the first rail. The door leaf further includes a housing adapted to at least partially enclose the framework and defining a hollow space between the first stile, the second stile, the first rail and the second rail. The door leaf also includes a filler material introduced into the hollow space to fill the hollow space and the first groove, thereby spreading to each one of the inner channels of the first and second stiles and sealing interstices between the first rail and the stiles.

According to a possible embodiment, the second rail has a second inner surface provided with a second groove extending therealong, said second groove being in fluid communication with each inner channel.

According to a possible embodiment, each rail and each stile includes a protective attachment connected thereto, wherein each inner channel is defined by each stile and the corresponding attachment.

According to a possible embodiment, each attachment is made of a polymeric material selected from the group consisting of polyvinyl chloride (PVC), polystyrene (PS), polyethylene (PE), low-density polyethylene (LDPE), high-density polyethylene (HDPE), polypropylene (PP), polyacrylonitrile, Teflon or thermoplastic polyurethanes.

According to a possible embodiment, the housing includes a pair of panels positioned on either sides of the framework and being secured thereto.

According to a possible embodiment, each panel includes a peripheral flange adapted to surround a respective portion of each attachment, therefore securing each attachment on their corresponding rail and/or stile.

According to a possible embodiment, the peripheral flanges surrounding the attachments of the stiles has a substantially “J-shape”.

According to a possible embodiment, the peripheral flanges surrounding the attachments of the rails has a substantially “L-shape”.

According to a possible embodiment, the rails are provided with a recessed edge respectively defining a gap between at least one of the panels and the recessed edge, the filler material being adapted to be injected within said gaps.

According to a possible embodiment, the attachment further defines a secondary channel along each stile, each secondary channel being in fluid communication with the gaps, thereby allowing the filler material to spread within the secondary channels.

According to a possible embodiment, the secondary channel of each stile is parallel and axially aligned with the inner channel of the same stile.

According to a possible embodiment, each rail and/or each stile is made of wood.

According to a possible embodiment, the filler material is a foam and the housing is made of steel.

According to a second aspect, a door system is provided. The door system includes a door frame having two opposite door jambs, and a header and a threshold connecting the door jambs to one another at a top end and a bottom end thereof respectively. The threshold has a top surface provided with a gutter adapted to gather and carry off water, the gutter extending along the top surface between the door jambs and having a cross-section defining a vertex and two sidewalls extending from said vertex and defining an angle therebetween.

According to a possible embodiment, the top surface of the threshold is inclined to direct water away from the door system.

According to a possible embodiment, the door system further includes a door leaf pivotally connected to the door frame and positionable between an open and closed configuration, the door leaf having a runoff system extending between the door jambs and being adapted to direct water flowing along the runoff system towards the gutter and/or away from the door leaf.

According to a possible embodiment, the runoff system includes an inclined top surface extending from the door leaf to direct water away from said door leaf.

According to a possible embodiment, the runoff system further includes a bottom surface and a sweep assembly, the sweep assembly being positioned along the bottom surface and being adapted to direct water toward said threshold and towards the gutter.

According to a possible embodiment, the sweep assembly includes a plurality of flexible elements extending from the bottom surface of the runoff system, each flexible element being adapted to redirect water by capillary action.

According to a possible embodiment, the flexible elements are parallel to one another.

According to a possible embodiment, when the door leaf is in the closed configuration, a first flexible element overhangs the threshold, a second flexible element contacts one of the sidewalls of the gutter, defining a contact line, and a third flexible element overhangs the gutter.

According to a possible embodiment, the sidewalls of the gutter extend above the top surface of the threshold.

According to a possible embodiment, the gutter defines an abutment adapted to have the door leaf abut thereon when in the closed configuration.

According to a third aspect, there is provided a door system including a door frame having a header and opposite facing door jambs, the header and door jambs having a first rabbet defining a first rabbet edge. The door frame further includes a first sealing element attached to the first rabbets. The door system also includes a door leaf pivotally connected to the door frame and positionable between an open and a closed configuration. The door leaf has a pair of opposite facing stiles and a pair of opposite facing rails, each pair comprising a second rabbet defining a second rabbet edge, said second rabbet edges defining a door plane. The door leaf also has a second substantially continuous sealing element attached to the second rabbets around a complete periphery of the door leaf. Finally, the door system includes door-system hardware, wherein the first and second sealing elements are located on a first side of the door plane and the door-system hardware is located on a second side of the door plane.

According to a possible embodiment, the first sealing element abuts against a surface of the door leaf facing the first rabbet edge upon positioning the door leaf in the closed configuration.

According to a possible embodiment, the header and door jambs further include a third rabbet defining a third rabbet edge, the second sealing element abutting against the third rabbet edge upon positioning the door leaf in the closed configuration.

According to a possible embodiment, the first and second sealing elements define an inner chamber therebetween upon positioning the door leaf in the closed configuration.

According to a possible embodiment, the first, second and third rabbet edges are substantially parallel to each other upon positioning the door leaf in the closed configuration.

According to a possible embodiment, the door-system hardware includes handles and/or knobs, hinges, locks, dead bolts and multi-point locking systems among others.

According to a possible embodiment, the first sealing element is a water barrier.

According to a possible embodiment, the first sealing element includes multiple portions connected to one another.

According to a possible embodiment, the multiple portions comprise at least one magnetic seal portion.

According to a possible embodiment, the multiple portions comprise at least one compression seal portion.

According to a possible embodiment, the second sealing element is an air barrier.

According to a fourth aspect, there is provided a door system including a door frame including two opposite door jambs; and a header and a threshold connecting the door jambs to one another at a top end and a bottom end thereof respectively, the header and door jambs including a first rabbet defining a first rabbet edge. The door frame further includes a first sealing element attached to the first rabbets for defining a first seal extending along corresponding sides of the door frame. The door system also includes a door leaf pivotally connected to the door frame and movable between an open and a closed configuration. The door leaf includes a pair of opposite facing stiles and a pair of opposite facing rails, each pair comprising a second rabbet defining a second rabbet edge; and a second substantially continuous sealing element attached to the second rabbets for defining a second seal extending along each side of the door leaf. The door system further includes a runoff system extending between the door jambs and being adapted to direct water away from the door leaf, the runoff system has at least one flexible element extending from a bottom surface thereof for engaging a top surface of the threshold, the at least one flexible element cooperating with the first sealing element such that the first seal extends along each side of the door frame.

According to a possible embodiment, the second rabbet edges define a door plane, and wherein the first and second sealing elements are located on a same side of the door plane.

According to a possible embodiment, the door system further includes door-system hardware, and wherein the first and second sealing elements are located on a first side of the door plane and the door-system hardware is located on a second side of the door plane.

According to a possible embodiment, the door-system hardware includes handles and/or knobs, hinges, locks, dead bolts and multi-point locking systems among others.

According to a possible embodiment, the top surface of the threshold is provided with a gutter adapted to gather and carry off water, the gutter extending along the top surface between the door jambs and having a cross-section defining a vertex and two sidewalls oppositely extending from said vertex.

According to a possible embodiment, the at least one flexible element is adapted to direct water towards the threshold and the gutter.

According to a possible embodiment, the at least one flexible element is adapted to redirect water by capillary action.

According to a possible embodiment, the at least one flexible element comprises a first flexible element overhanging the threshold, a second flexible element contacting one of the sidewalls of the gutter, defining a contact line therewith, and a third flexible element overhanging the gutter.

According to a possible embodiment, each flexible element is parallel to the other flexible elements.

According to a possible embodiment, the sidewalls of the gutter extend above the top surface of the threshold.

According to a possible embodiment, the gutter defines an abutment adapted to have the door leaf abut thereon when in the closed configuration.

According to a possible embodiment, the top surface of the threshold is inclined to direct water away from the door system.

According to a possible embodiment, the runoff system includes an inclined top surface extending from the door leaf to direct water away from the door leaf.

According to a possible embodiment, the first sealing element abuts against a surface of the door leaf facing the first rabbet edge when in the closed configuration.

According to a possible embodiment, the header and door jambs further include a third rabbet defining a third rabbet edge, the second sealing element abutting against the third rabbet edge when in the closed configuration.

According to a possible embodiment, the first, second and third rabbet edges are substantially parallel to each other when in the closed configuration.

According to a possible embodiment, the first and second sealing elements define an inner chamber therebetween when in the closed configuration.

According to a possible embodiment, the first sealing element is a water barrier.

According to a possible embodiment, the first sealing element includes multiple portions connected to one another.

According to a possible embodiment, the multiple portions comprise at least one magnetic seal portion.

According to a possible embodiment, the multiple portions comprise at least one compression seal portion.

According to a possible embodiment, the second sealing element is an air barrier.

### BRIEF DESCRIPTION OF THE DRAWINGS

FIG. 1 is an exploded view of a door system according to an embodiment;

FIG. 2 is a front elevation view of the door system seen in FIG. 1;

FIG. 2A is a cross-sectional view taken along lines 2A-2A of FIG. 2;

FIG. 2B is a cross-sectional view taken along lines 2B-2B of FIG. 2;

FIGS. 3A to 3P are schematic views of examples of cross-sections of a gutter of the door system, in accordance with some embodiments;

FIG. 4 is a sectional view of the door system seen in FIG. 2, showing a corner of a door leaf in a closed configuration with respect to a door frame according to an embodiment;

FIG. 5 is an exploded view of a door leaf showing a framework and housing of said door leaf, in accordance with an embodiment;

FIG. 5A is an enlarged view of an end of a stile of the framework, showing a rabbeted edge at said end, according to an embodiment;

FIG. 5B is an enlarged view of an end of a rail of the framework, showing a location of a groove thereon, according to an embodiment;

FIG. 6 is a sectional view of the door system seen in FIG. 2, showing the door leaf in a closed configuration with respect to the door frame, and a first and second sealing element therebetween;

FIG. 7 is a schematic view of a panel flange rolled into a “J-shape” according to an embodiment.

FIG. 8 is a sectional view of the door system seen in FIG. 2, showing the fluid communication between elements of the door leaf, according to an embodiment.

FIGS. 8A and 8B are sectional views of a corner of the door leaf, showing the fluid communication between elements of the door leaf, according to an embodiment.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Furthermore, although the present invention may be used with a door system, for example, it is understood that it may be used with other types of doors, for other purposes. For this reason, expressions such as “door system”, “door frame”, “door leaf”, “door glass” etc. as used herein should not be taken as to limit the scope of the present invention to being used with high performance doors in particular. These expressions encompass all other kinds of materials, objects and/or purposes with other types of doors with which the present invention could be used and may be useful.

Moreover, it will be appreciated that positional descriptions such as “longitudinal”, “transversal”, “left”, “right”, “upper”, “lower”, “external”, “internal”, “outer”, “inner”, “oblique”, “parallel”, “perpendicular” and the like should be taken in the context of the figures only and should not be considered limiting. Moreover, the figures are meant to be illustrative of certain characteristics of the door system and are not necessarily to scale.

In addition, although the optional configurations as illustrated in the accompanying drawings comprises various components and although the optional configurations of the door system as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the door system, and corresponding parts, as briefly explained and as can be easily inferred herefrom, without departing from the scope of the disclosure.

As will be explained below in relation to various embodiments, a door system for accessing a building, housing and/or room is provided. The door system includes a door leaf pivotally coupled to a door frame so as to be operable between a closed configuration and an open configuration. It should be understood that, as used herein, the expression “door leaf” refers to the movable/pivoting portion of the door system. As should be readily understood by a person skilled in the art, the door frame includes two opposite door jambs joined to one another by a header at respective top ends thereof. The door frame can also include a threshold (or sill) adapted to further join the door jambs at respective bottom ends thereof.

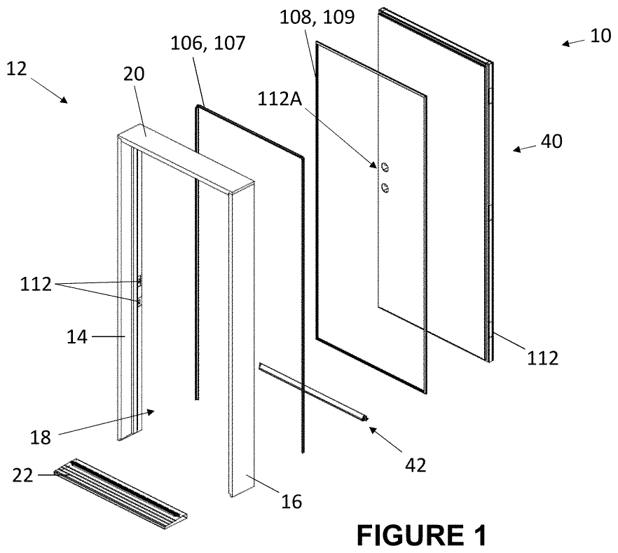

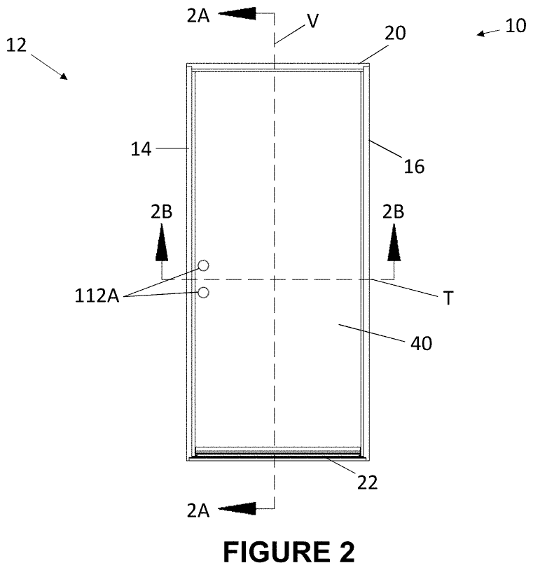

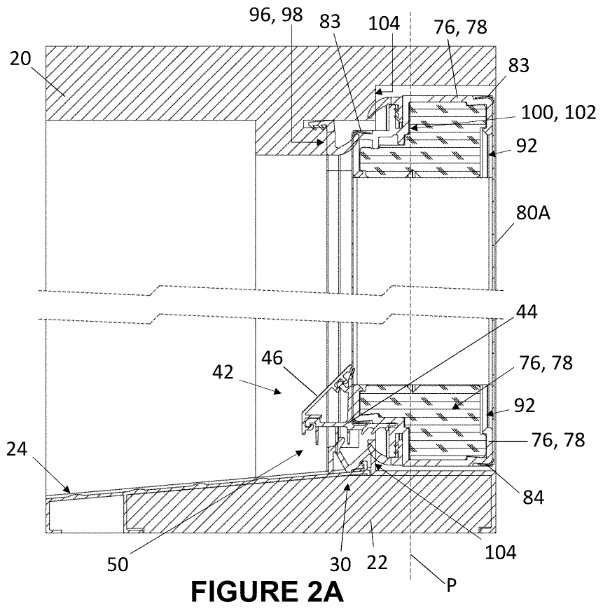

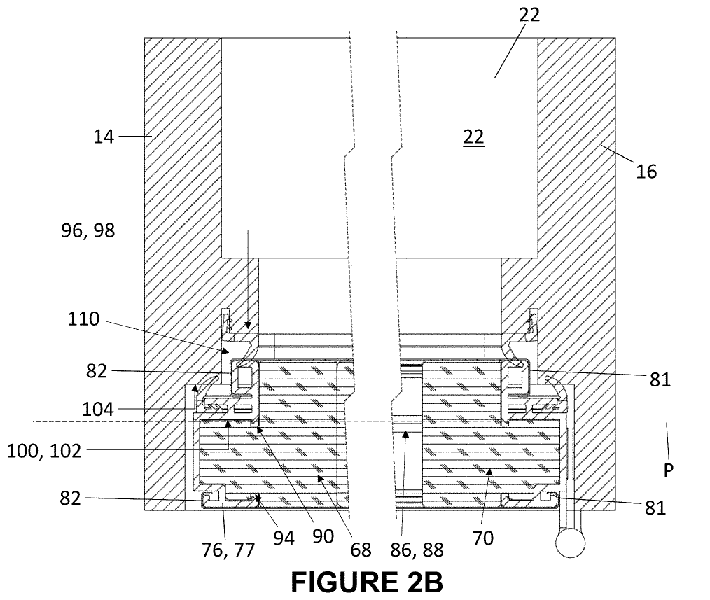

Referring to FIGS. 1 and 2, a door system 10 in accordance with one embodiment is shown. In this embodiment, the door system 10 includes a door frame 12 comprising a first door jamb 14 and a second door jamb 16 spaced apart from the first door jamb 14. It should be understood that said door jambs are preferably parallel to one another in order to define a conventional (i.e. straight) door opening 18, although it is appreciated that other configurations are possible. Furthermore, the door frame 12 also comprises a header 20 adapted to join a top end of the first door jamb 14 with a top end of the second door jamb 16. The frame 12 can also include a threshold 22 adapted to join a bottom end of the first door jamb with a bottom end of the second door jamb. In this embodiment, the aforementioned door opening 18 is further defined by said header 20 and threshold 22.

Now referring to FIGS. 2A and 2B, in addition to FIG. 1, the threshold 22 has a top surface 24 extending between the door jambs 14, 16 and is preferably inclined so as to direct water away from the door opening 18. However, it is appreciated that the top surface 24 can alternatively have any suitable orientation, such as being substantially parallel to the ground for example. In some embodiments, the top surface 24 is provided with a gutter 30 adapted to gather and/or carry off water accumulated therein. In this embodiment, the gutter 30 extends along the top surface 24 of the threshold 22 between the door jambs 14, 16. It should be noted that the gutter 30 can extend from one door jamb to the other, or simply along a portion of the threshold 22.

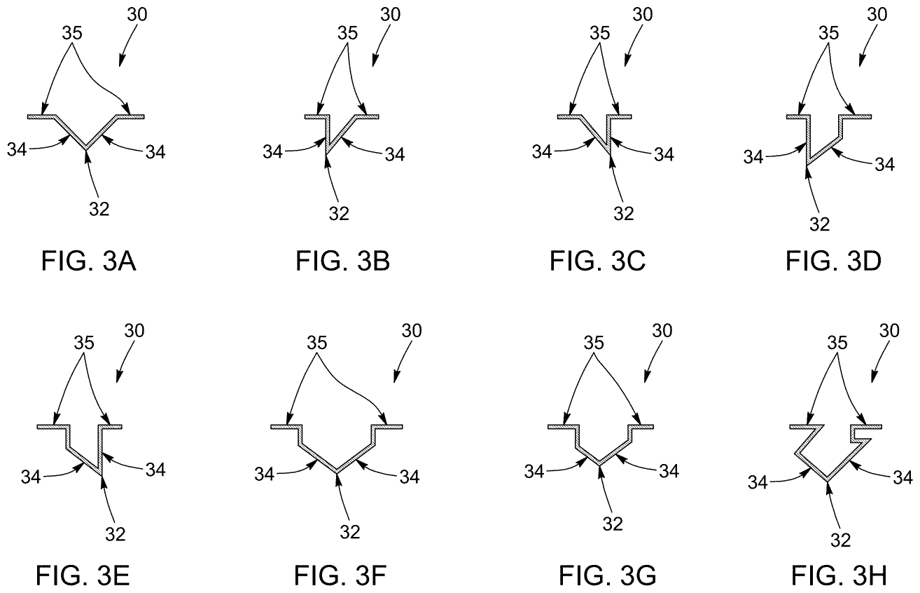

As seen in the exemplary embodiment of FIG. 3A, the gutter 30 has a cross-section defining a vertex 32, and two sidewalls 34 extending from said vertex 32 and defining an angle therebetween. It is appreciated that the sidewalls 34 can be positioned so as to define any suitable angle therebetween so as to guide water towards the vertex 32. For example, the angle defined by the sidewalls 34 can be between about 45 and about 135 degrees. In this embodiment, the gutter 30 has a substantially V-shape so as to direct any water that would gather therein towards the vertex 32. As illustrated in FIG. 2A, the sidewalls can extend above the top surface 24 of the threshold 22 in a manner that will be further explained below.

It should be understood that the term “vertex”, as used herein, refers to a point where two or more sidewalls of the gutter meet. FIGS. 3A to 3P all show non-limiting embodiments of a vertex 32 provided at the juncture point of sidewalls 34 of the gutter 30. In other words, referring to FIGS. 3A to 3P, multiple embodiments of the cross-sectional shape of the gutter 30 are illustrated for exemplary purposes. In these embodiments, it should be understood that the gutter 30 can have a variety of shapes with additional sidewalls 34 defining various angles therebetween. It is appreciated that the vertex 32 remains the lowest point in the gutter so as to facilitate the flow of water towards said vertex 32. In some embodiments, the vertex 32 can have a minimally flat and/or rounded point, depending on the fabrication method and the tools used for manufacturing.

More specifically, the embodiments illustrated in FIGS. 3A to 3C provide gutters 30 having sidewalls 34 joining a top edge 35 of the gutter with the vertex 32. In these embodiments, the sidewalls 34 can extend from the vertex 32 with a similar angle (FIG. 3A) or with different angles (FIGS. 3B and 3C). Additionally, it is appreciated that one of the sidewalls 34 can be substantially vertical. In the following embodiments, namely those of FIGS. 3D to 3G, at least one of the sidewalls 34 can extend from the vertex 32 to a point located below the top edge 35 before extending vertically to said top edge 35. In some embodiments, the sidewalls 34 can extend to a point located below the top edge 35 so as to have said top edge 35 overhang a portion of the gutter 30 (FIG. 3H) before extending back to join said top edge 35, either directly or indirectly. In other embodiments, the top edge 35 can completely overhang the vertex 32 while the sidewalls 34 extend from said vertex 32 towards the top edge 35 in any configuration, or combination(s) thereof, described above (e.g., FIGS. 31 to 3P).

Referring back to FIGS. 1 and 2, the door system 10 further includes a door leaf 40 pivotally connectable to the door frame 12 (e.g., via hinges) and being operable between a closed configuration and an open configuration so as to control access of the door opening 18. It will be readily understood that the door leaf 40 can define a vertical axis V being parallel to the door jambs 14, 16, and a transverse axis T extending between said door jambs and being perpendicular to said vertical axis V. In some embodiments, the door system 10 further comprises a runoff system 42 extending along the door leaf 40 in a substantially parallel manner to the transverse axis T of said door leaf 40. The runoff system 42 can be adapted to direct water flowing thereon towards the gutter 30 and/or away from the door leaf 40. As illustrated in FIG. 2A, the runoff system 42 can be attached to a lower portion of the door leaf 40 via a fixture 44 and further includes a runoff surface 46 attached to said fixture 44. In this embodiment, the runoff surface 46 has an inclined portion adapted to direct water flowing thereon away from the door leaf 40.

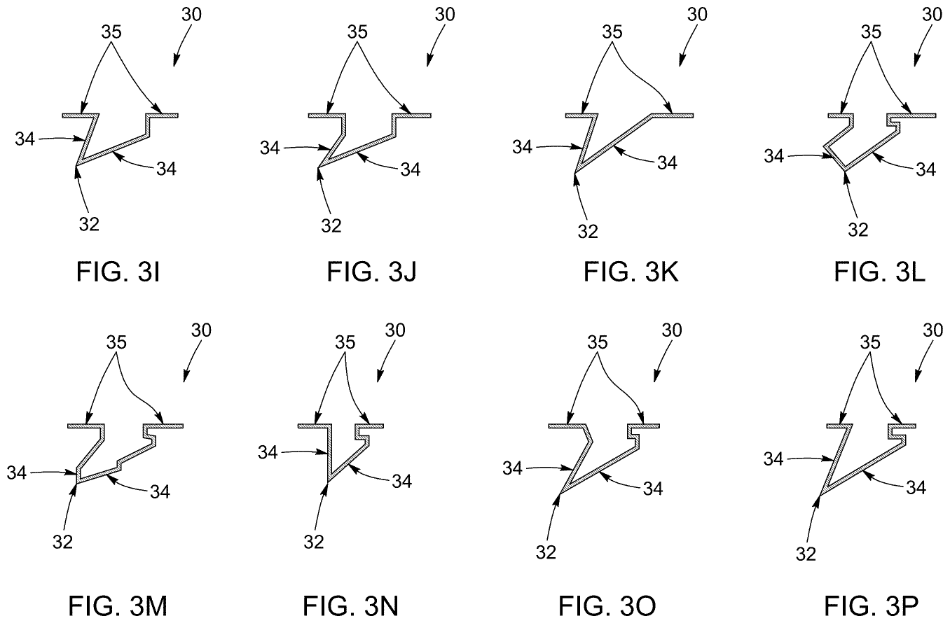

With reference to FIG. 4, in addition to FIG. 2A, the runoff system 42 further comprises a sweep assembly 50 connected to the fixture 44. In some embodiments, the sweep assembly 50 is adapted to redirect water, such as water flowing from the runoff surface 46, towards the threshold 22 and/or gutter 30, so as to have said water be ultimately carried away from the door system 10. The sweep assembly 50 can include a plurality of flexible elements 52 positioned along the fixture 44 and extending downwardly therefrom. In this embodiment, each flexible element 52 can be adapted to redirect water flowing from the runoff surface 46, or elsewhere, by capillary action. As such, it should be understood that the flexible elements 52 are preferably made of a flexible/malleable material, such as rubber for example, or any other suitable material. In the present embodiment, the flexible elements 52 are substantially parallel and spaced apart from one another. In this embodiment, the sweep assembly 50 comprises three flexible elements 52, namely a first flexible element 54, a second flexible element 56 and a third flexible element 58. However, it is appreciated that the sweep assembly 50 can include any suitable number of flexible elements 52 arranged along the fixture 44.

Upon positioning the door leaf 40 in the closed configuration, and as illustrated in FIGS. 2A and 4, the first flexible element 54 is positioned so as to overhang the threshold 22 of the door frame 12. As such, any water that would drip from said first flexible element 54 would ultimately be carried away from the door leaf 40 by the inclined top surface 24. In this embodiment, the second flexible element 56 is positioned so as to contact one of the sidewalls 34 of the gutter 30 while the door leaf 40 is in the closed configuration (FIG. 4). More specifically, the second flexible element 56 contacts a top edge of the corresponding sidewall 34, therefore defining a contact line therebetween. It is appreciated that in alternate embodiments, the second flexible element 56 can contact a surface of the sidewall 34, thus defining a contact surface therebetween. It is further appreciated that the second flexible element 56 can define a barrier for water that could flow through the door system 10 between the runoff system 42 and the gutter 30. Furthermore, the third flexible element 58 can be positioned so as to overhang the gutter 30, either above one of the sidewalls 34 or aligned with the vertex 32. As such, any water that would drip from the third flexible element 58 would gather within the gutter 30 and be carried away from the door system 10.

In some embodiments, upon changing the position of the door leaf 40 (i.e. going from the closed configuration to the open configuration or vice-versa), the first flexible element 54 is adapted to bend in a corresponding direction so as to go over the gutter 30. In this embodiment, the first flexible element 54 is the only element adapted to completely go over the gutter 30 upon positioning the door leaf 40 in the closed configuration. It will thus be understood that the second and third flexible elements 56, 58 can similarly bend to go over a single one of the sidewalls 34. It is appreciated that each of the first, second and third elements can be shaped and configured to bend in a single direction during operation of the door leaf 40 so as to prevent said elements from bending in an “S-pattern”. This feature can effectively reduce bending stresses in the flexible elements 52 thus improving life expectancy of the sweep assembly 50.

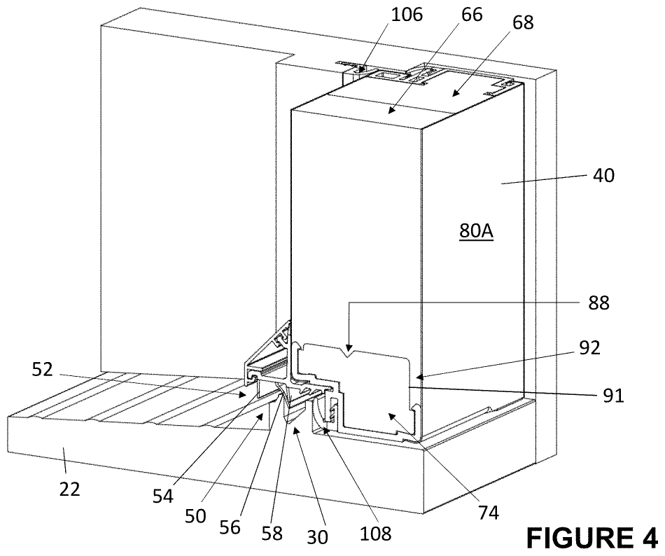

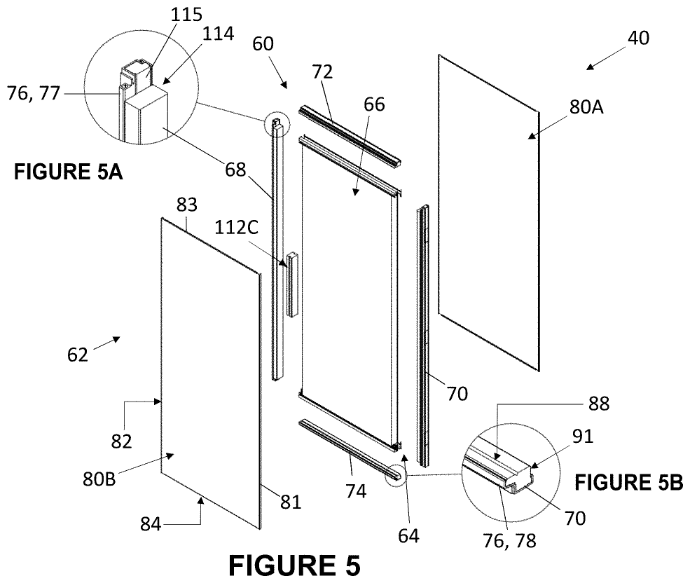

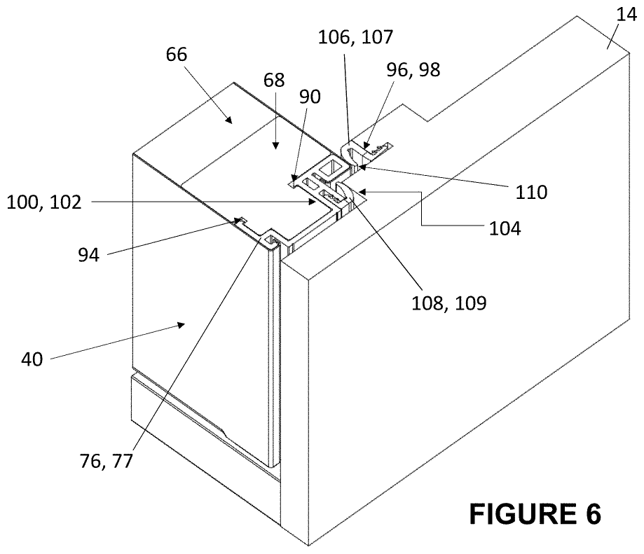

As will be readily understood by a person skilled in the art, and with reference to FIG. 5, the door leaf 40 can include a framework 60 having a housing 62 at least partially enclosing said framework 60 so as to define a hollow space 64 therebetween. More specifically, the housing 62 can completely enclose the framework 60 thus preventing said framework from being seen from the outside. Alternatively, the housing 62 can be attached to a portion of the framework, for example around an outer periphery thereof, therefore allowing the framework to be seen from the outside. The cooperation between the housing 62 and the framework 60 will be further described below.

In some embodiments, a filler material 66 can be introduced, for example by being injected or sprayed, into the hollow space 64 so as to at least partially fill said hollow space 64 to impart better rigidity to the door leaf 40. In some embodiments, the filler material 66 is a foam-like material, such as polyurethane foam, cementitious foam, phenolic injection foam or any other suitable foam material. The filler material 66 can be further adapted to evacuate air from the hollow space 64 and improve insulation of the door leaf 40 in a manner that will be described below.

In this embodiment, the framework 60 of the door leaf 40 includes a first stile 68 and a second stile 70 spaced apart from the first stile 68. Additionally, the framework 60 includes a first rail 72 joining a first end of the first stile 68 with a first end of the second stile 70, and a second rail 74 joining a second end of the first stile 68 with a second end of the second stile 70. It should thus be understood that the hollow space 64 can correspond to the space defined between the first stile 68, the second stile 70, the first rail 72 and the second rail 74. Moreover, in this embodiment, the first rail 72 generally corresponds to a top rail 73 while the second rail 74 generally corresponds to a bottom rail 75.

In some embodiments, the framework 60 can be provided with injection holes (not shown) allowing injection of the filler material 66 within the hollow space 64. More specifically, the stiles 68, 70 and/or rails 72, 74 can include one or more injection holes along their respective lengths in fluid communication with the hollow space 64. It should be understood that each injection hole can be shaped and sized to allow insertion/engagement of an injection tool therein for injecting filler material 66 within the hollow space 64. In one embodiment, each rail 72, 74 can be provided with a single injection hole so as to fill the hollow space from the top and the bottom of the door leaf 40 substantially simultaneously. However, it is appreciated that additional holes can be provided along the lengths of the rails for injecting filler material 66 within the hollow space 64 more evenly along the lengths of the rails. It is further appreciated that the holes can be spaced substantially evenly along the rails or in any suitable configuration. It should also be understood that once the injection of the filler material 66 within the hollow space 64 is finished, the injection holes can be similarly filled and sealed by said filler material 66 as it sets within the hollow space 64.

In some embodiments, each element of the framework 60 is preferably made of wood, but can alternatively be made of plastic, metal or any suitable material and/or combination thereof. Referring back to FIGS. 2A and 2B, each element of the framework 60 respectively includes an outer portion and an attachment 76 connected to said outer portion. More specifically, each stile 68, 70 is provided with a stile attachment 77 and each rail 72, 74 is provided with a rail attachment 78.

The attachments 76 can be adapted to protect the elements of the framework from external elements such as water and humidity, while providing a clean look to each one of said elements. The attachments 76 can be made from of a polymeric material such as polyvinyl chloride (PVC), polystyrene (PS), polyethylene (PE), low-density polyethylene (LDPE), high-density polyethylene (HDPE), polypropylene (PP), polyacrylonitrile, Teflon, thermoplastic polyurethanes or any other suitable material. Moreover, the attachments 76 can be shaped and sized to conform to the geometry of the outer portions it is connected to. As such, the attachments 76 can be clipped into position and snugly surround their corresponding element.

With reference to FIG. 5, the housing 62 of the door leaf 40 illustratively includes two substantially rectangular panels 80 positioned on either side of the framework 60. In some embodiments, the panels 80 are metallic sheets, such as steel or aluminium, but can alternatively be made from fiber glass, wood, plastic or any other suitable material. It is appreciated that the panels 80 can include an inner panel 80A and an outer panel 80B. For example, the inner panel 80A can face the inside of the house or building, while the outer panel 80B faces outside. In the illustrated embodiment, each panel 80 includes outer flanges adapted to surround and connect to a portion of each attachment 76, further securing said attachments 76 to the corresponding elements of the framework 60. More specifically, each panel 80 includes a pair of oppositely facing side flanges 81, 82 and a pair of oppositely facing transverse flanges 83, 84. As illustrated in FIGS. 2A and 2B, each side flange 81, 82 can be rolled into a “J-shape” around a portion of the stile attachments 77 covering the stiles 68, 70 and each transverse flange 83, 84 can be bent into an “L-shape” around the rail attachments 78 covering the rails 72, 74.

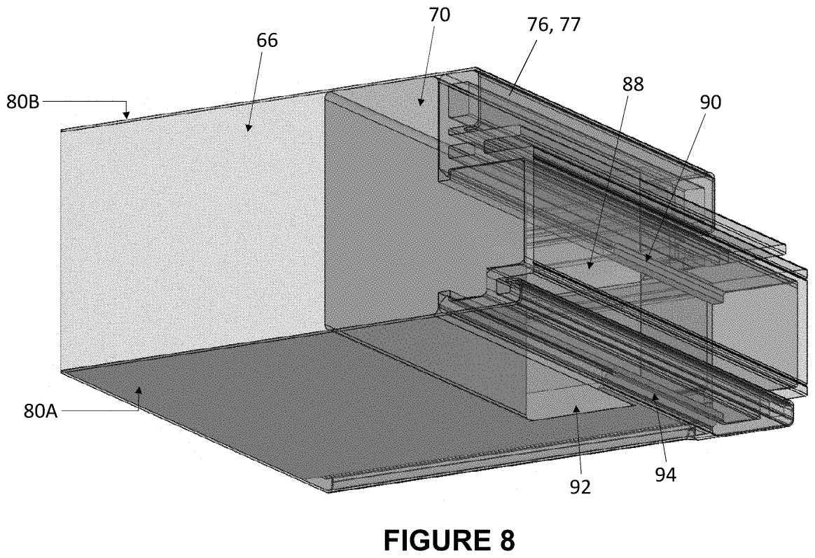

With reference to FIG. 7, an enlarged view of the aforementioned “J-shape” of the side flange 81 is shown for exemplary purposes. As illustrated, the side flange 81 comprises a first portion 81A and a second portion 81B adapted to hook around a portion of the corresponding attachment 77. It should be understood that the first and second portions 81A, 81B can have any suitable length so as to snugly hook around the attachment. It is further appreciated that other configurations of the outer flanges could be used to connect said flanges to the attachments 76, such as having all four flanges rolled into a “J-shape” for example.

In some embodiments, adjacent elements of the framework 60 define a junction which can include interstices susceptible of reducing the insulation and/or the soundproofing of the door leaf 40. In order to substantially seal and/or narrow these interstices, the framework 60 can be provided with an inner circuit 86 (FIG. 2B) adapted to fluidly connect adjacent elements of the framework 60 to one another. More particularly, the inner circuit can allow the junctions of these elements to be filled with filler material 66 thereby substantially sealing and/or narrowing the aforementioned interstices.

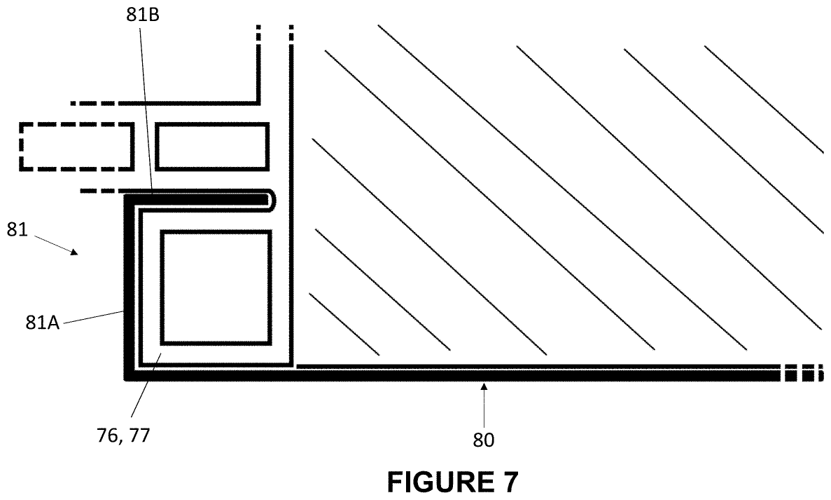

With reference to FIGS. 4 and 6, the inner circuit 86 of the framework 60 comprises grooves and channels provided along the elements of the framework 60. More specifically, at least one of the rails 72, 74 has an inner surface which can be provided with a groove 88 longitudinally extending along said inner surface, while the stiles 68, 70 can be respectively provided with an inner channel 90 extending along a length thereof. In the illustrated embodiments, the grooves 88 are generally V-shaped and located substantially in the middle of the rails. However, it should be understood that the grooves 88 can have any other suitable shape, such as a half-pipe or have square edges for example. In this embodiment, the inner channels 90 are defined by a space provided between the stile attachments 77 and the corresponding stile. As such, the shape of the inner channels 90 is defined by the cooperating surfaces of the attachments 77 and the stiles. It is appreciated that the inner channels 90 can thus have a cross-section defining any suitable shape such as circular, triangular and/or square for example.

In the present embodiment, the first rail 72 has a first inner surface, and the second rail 74 has a second inner surface. Said inner surfaces are respectively provided with a groove 88 being in fluid communication with the inner channels 90. As such, when filler material 66 is injected within the hollow space 64 of the door leaf 40, the grooves 88 are filled with said filler material 66 which further spreads within each one of the inner channels 90 thereby evacuating air from the hollow space, grooves and inner channels, and sealing the junction (i.e. interstices) between the rails and stiles.

In some embodiments, the rails 72, 74 can be respectively provided with a recessed edge 91 (FIGS. 4 and 5B) extending along the lengths thereof. As such, upon positioning the corresponding panel 80 on the framework, the panels 80 and rails 72, 74 can define at least one gap 92 between said panel 80 and recessed edges 91. As illustrated in FIGS. 2A, 2B and FIG. 4, the gaps 92 are located between the inner panel 80A and the rails 72, 74, although it is appreciated that other configurations are possible. For example, the rails 72, 74 can be provided with a second recessed edge and thus additional gaps 92 could be located between said rails and the outer panel 80B.

In some embodiments, each stile attachment 77 further defines a secondary channel 94 (FIGS. 2B and 6) extending along their corresponding stile. In the present embodiment, the gaps 92 are an extension of the hollow space 64 and can thus be filled with the filler material 66. In addition, the secondary channels 94 can be in fluid communication with said gaps 92, thus allowing the filler material 66 to spread therein, further sealing the junctions between adjacent elements of the framework 60. In the illustrated embodiment, each secondary channel 94 is parallel and axially aligned with the inner channel 90 of the same stile. However, it is appreciated that non-aligned and/or parallel channels could be used for the purpose of sealing interstices within junctions of the framework 60.

It is appreciated that in the context of the present disclosure, the rails can be provided with a system of grooves (not shown). More specifically, the system of grooves can comprise two or more grooves extending along the length of the corresponding rails. It is further appreciated that for the purpose of sealing the framework junctions, the grooves 88 and/or inner channels 90 do not have to extend for the full length of their corresponding elements.

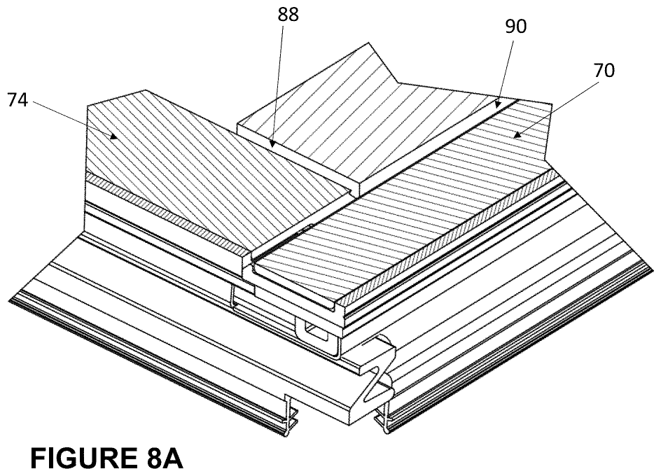

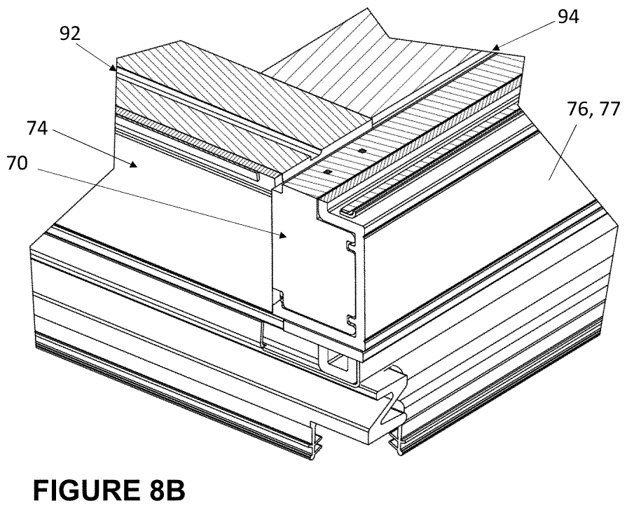

With reference to FIGS. 8 to 8B, in addition to FIG. 5, a sectional view of a junction of the framework 60 is illustrated. In this embodiment, the filler material 66 is introduced in the hollow space 64, groove 88 and gap 92, and spreads within the inner channel 90 and secondary channel 94. As illustrated in FIGS. 8 to 8B, and as described above, the filler material 66 from the groove 88 spreads within the inner channel 90 (FIG. 8A), and the filler material 66 from the gap 92 spreads within the secondary channel 94 (FIG. 8B). Once the channels 90, 94 are filled, the filler material 66 can exit said channels from the end of the stile 70, thus evacuating the air from within the channels and sealing the junction of the framework 60. In the present embodiment, the filler material 66 injected within the gap 92 can be further adapted to connect the panel 80A to the corresponding rail 72, 74. More specifically, in some embodiments, the filler material 66 can act as an adhesive agent once it sets within the hollow space 64, grooves 88, gaps 92 and/or channels 90, 94.

Referring back to FIGS. 2A, 2B and 6 the header 20 and door jambs 14, 16 of the door frame 12 can be provided with a first rabbet 96 defining a first rabbet edge 98 extending substantially around a periphery of the door frame 12. Similarly, each element of the framework 60 of the door leaf 40 can be provided with a second rabbet 100 defining a second rabbet edge 102 extending around a periphery of the door leaf 40. Additionally, the door frame 12 components (door jambs 14, 16, header 20 and threshold 22) can be provided with an abutment edge 104 adapted to have the door leaf 40 abut thereon in a manner that will be described below. In the present embodiment, the second rabbet edge 102 is substantially continuous around the entire periphery of the door leaf 40 along a common plane P.

In some embodiments, the door system 10 can be provided with sealing elements connected to the door frame 12 and/or the door leaf 40 for effectively sealing the door system 10 from air and/or water for example. More particularly, and as illustrated in FIGS. 1, 4 and 6, the door system 10 includes a first substantially continuous sealing element 106 being connected to the first rabbet edge 98 around the periphery of the door frame 12 (or a portion thereof). It should be understood that, as used herein, the expression “substantially continuous sealing element” can refer to an element made from a single piece of material which is bent and/or curved around the periphery of the door frame, or an element made from several pieces of material (i.e., portions) attached to one another, using glue for example, and positioned around the periphery of the door frame. For example, the first sealing element 106 can include one or more magnetic seals connected to one or more compression seals for least partially surrounding the periphery of the door frame.

The door system 10 can further include a second substantially continuous sealing element 108 connected to the second rabbet edge 102 around the periphery of the door leaf 40. In some embodiments, the first sealing element 106 can be a water barrier 107 and the second sealing element 108 can be an air barrier 109. This configuration provides a substantially continuous seal around the entire periphery of the door opening 18 so as to insulate the door system 10. It should be understood that the water barrier 107 is adapted to prevent water from flowing through the door system 10, therefore protecting the air barrier 109 from said water. The air barrier 109 is further protected from temperature changes due to climate stresses such as wind-driven rain for example. It should be further understood that the air barrier 109 is adapted to prevent air from flowing through the door system 10.

Still referring to FIGS. 4 and 6, and as also seen in FIGS. 2A and 2B, when positioning the door leaf 40 in the closed configuration, the first sealing element 106 is adapted to abut against the outer panel 80B of the door leaf 40 and the second sealing element 108 is adapted to abut against the abutment edge 104 of the door frame 12, effectively sealing the door system 10. In some embodiments, the first and second sealing elements 106, 108 can define a chamber 110 therebetween extending around the periphery of the door opening 18. In this embodiment, the first and second rabbet edges 98, 102 and the abutment edge 104 are parallel to each other upon positioning of the door leaf 40 in the closed configuration. However, it is appreciated that other configurations of the rabbets/rabbet edges (i.e. depth of rabbets, angle of edges, etc.) are possible.

As is well known in the art, the door system 10 includes door system hardware 112 adapted to facilitate operation of the door. More specifically, the door system hardware 112 can include handles 112A (FIGS. 1 and 2), hinges 112B (FIG. 2B), locks, deadbolts 112C (FIG. 5), multi-point locking systems and/or others. In this embodiment, the entirety of the door system hardware is located on a first side of the plane P (FIGS. 2A and 2B) and the first and second sealing elements 106, 108 are located on a second side of the door plane P. As will be readily understood, the door plane P is used for exemplary purposes only. Indeed, a person skilled in the art will understand that any other suitably located door plane, parallel to door plane P, can be used in the context of this disclosure, as long as the sealing elements 106, 108 are separated from the door system hardware 112 by said plane. It should be further understood that the overall width (thickness) of the door leaf 40 allows both sealing elements 106, 108 to be installed away from the hardware 112. As such, the sealing elements are not interrupted by the components of the door system hardware 112.

With reference to FIGS. 5 to 5B, a manufacturing process of the door leaf 40 will be described. First, the elements of the framework 60 may be cut from pieces of wood in appropriately-sized lumber. Then, the grooves 88 are provided along the rails 72, 74 using any suitable tool(s). Each element of the framework can then be provided with the corresponding attachment 76, which simultaneously defines the inner channels 90 and secondary channels 94 along the stiles 68, 70. As illustrated in FIG. 5A, the stiles 68, 70 are provided with an end rabbet 114 defining an end rabbet edge 115 adapted to have corresponding rails abut thereon and be connected thereto, thus forming the framework 60. It should be understood that the first and second ends of the stiles may be provided with respective end rabbet edges 115. Therefore, it will be appreciated that the channels 90, 94 can extend along the end rabbet edges 115 so as to reach the end of the corresponding stile. It should thus be understood that, in the illustrated embodiment, the grooves 88 are aligned with the inner channels 90 upon positioning the rails on the end rabbet edge 115, thus allowing fluid communication between said grooves and inner channels. Additionally, it will be further understood that the gaps 92 can also be positioned so as to be in fluid communication with the secondary channels 94.

In order to fixedly connect the elements of the framework to one another, the panels 80 may be attached on either side of the framework 60 and can further be respectively embedded into the attachments 76. Once the panels 80 are fixedly attached, the hollow space 64 defined within the door leaf 40 can be filled with filler material 66 (i.e. insulation foam), filling the grooves 88, inner channels 90, gaps 92 and secondary channels 94 at the same time. More specifically, the filler material 66 can initially fill the hollow space 64, grooves 88 and gaps 92. Once the hollow space 64, grooves 88 and gaps 92 are filled, the filler material 66 can spread into the inner channels 90 and secondary channels 94 in order to seal the interstices located between adjacent elements of the framework 60. It will be understood that upon filling the channels 90, 94, the filler material 66 can exit said channels at the end of the corresponding stiles so as to prevent any damages to the door leaf 40, for example by accidentally “overfilling” the hollow space, grooves and/or channels.

It will be readily understood by a person skilled in the art that the door system hardware (knob, hinges, deadbolt, etc.) can be installed/attached to the framework 60 at any point during the assembly of the door leaf 40 as described above. Once the assembly is complete, the door leaf 40 can be pivotally connected to the door frame 12 for operation.

It will be appreciated from the foregoing disclosure that there is provided a door system, which is provided with dual sealing elements, better insulation between the junctions of the door leaf and an improved gutter. As such, the system can offer substantial improvements over the known prior art in that, in virtue of its design and components, as explained herein, it advantageously enables to a) increase insulation of the building or house it is installed in, thus reducing costs associated with heating or cooling due to heat transfer through the door (i.e. poor insulation and/or air leakage); b) increase lifetime expectancy of the various components comprising the door system, and many more. However, the scope of the claims should not be limited by the preferred embodiments set forth in the examples, but should be given the broadest interpretation consistent with the description as a whole.

1. A door system comprising:
a door frame comprising:
two opposite door jambs; and
a header and a threshold connecting the door jambs to one another at a top end and a bottom end thereof respectively, the header and door jambs including a first rabbet defining a first rabbet edge;
a first sealing element attached to the first rabbets for defining a first seal extending along corresponding sides of the door frame; and
a door leaf pivotally connected to the door frame and movable between an open and a closed configuration, the door leaf comprising:
a pair of opposite facing stiles and a pair of opposite facing rails, each pair comprising a second rabbet defining a second rabbet edge; and
a second substantially continuous sealing element attached to the second rabbets for defining a second seal extending along each side of the door leaf; and
a runoff system extending between the door jambs and being adapted to direct water away from the door leaf,
the runoff system comprising at least one flexible element extending from a bottom surface thereof for engaging a top surface of the threshold, the at least one flexible element cooperating with the first sealing element such that the first seal extends along each side of the door frame.

2. The door system according to claim 1, wherein the second rabbet edges define a door plane, and wherein the first and second sealing elements are located on a same side of the door plane.

3. The door system according to claim 2, the door system further comprising door-system hardware, and wherein the first and second sealing elements are located on a first side of the door plane and the door-system hardware is located on a second side of the door plane.

4. The door system according to claim 3, wherein the door-system hardware includes handles and/or knobs, hinges, locks, dead bolts and multi-point locking systems among others.

5. The door system according to claim 1, wherein the top surface of the threshold is provided with a gutter adapted to gather and carry off water, the gutter extending along the top surface between the door jambs and having a cross-section defining a vertex and two sidewalls oppositely extending from said vertex.

6. The door system according to claim 5, wherein the at least one flexible element is adapted to direct water towards the threshold and the gutter.

7. The door system according to claim 5, wherein the at least one flexible element is adapted to redirect water by capillary action.

8. The door system according to claim 5, wherein the at least one flexible element comprises a first flexible element overhanging the threshold, a second flexible element contacting one of the sidewalls of the gutter, defining a contact line therewith, and a third flexible element overhanging the gutter.

9. The door system according to claim 8, wherein each flexible element is parallel to the other flexible elements.

10. The door system according to claim 5, wherein the sidewalls of the gutter extend above the top surface of the threshold.

11. The door system according to claim 5, wherein the gutter defines an abutment adapted to have the door leaf abut thereon when in the closed configuration.

12. The door system according to claim 1, wherein the top surface of the threshold is inclined to direct water away from the door system.

13. The door system according to claim 1, wherein the runoff system comprises an inclined top surface extending from the door leaf to direct water away from the door leaf.

14. The door system according to claim 1, wherein the first sealing element abuts against a surface of the door leaf facing the first rabbet edge when in the closed configuration.

15. The door system according to claim 1, wherein the header and door jambs further include a third rabbet defining a third rabbet edge, the second sealing element abutting against the third rabbet edge when in the closed configuration.

16. The door system according to claim 15, wherein the first, second and third rabbet edges are substantially parallel to each other when in the closed configuration.

17. The door system according to claim 1, wherein the first and second sealing elements define an inner chamber therebetween when in the closed configuration.

18. The door system according to claim 1, wherein the first sealing element is a water barrier and the second sealing element is an air barrier.

19. The door system according to claim 18, wherein the multiple portions comprise at least one magnetic seal portion.

20. The door system according to claim 18, wherein the multiple portions comprise at least one compression seal portion.
